(19) United States
(12) Patent Application Publication
(10) Pub. No.: US 2001/0030605 A1
(43) Pub. Date: Oct. 18, 2001

(54) Burglar alarm and door chime

(76) Inventor: Raymond J. Novotny, Fogelsville, PA (US)

Correspondence Address: Raymond J. Novotny, 2345 Hailey Court, Fogelsville, PA, 18051, US

(21) Appl. No.: 09/811,134

(22) Filed: Mar. 17, 2001

Related U.S. Application Data
(60) Provisional application No. 60/195,704, filed on Apr. 7, 2000.

(51) Int. Cl. G08B 13/08

(52) U.S. Cl. 340/545.1; 340/545.3; 340/545.7

(57) ABSTRACT

An improved battery operated combination burglar alarm and door chime mounted to the inside of a door from where the alarm and chime modes are selected. A dead bolt slide cooperates with a jamb plate fastened to the door frame to manually arm the device from the inside with the door closed. Opening the door activates the dead bolt and sounds the alarm. A magnetically sensitive switch within the device cooperates with a magnet fastened to the jamb plate and further cooperates with a mode selection switch to effect either the chime mode or delayed alarm mode when the door is opened. The delayed alarm mode is activated with the door open to permit pre-arming the device followed by automatic arming of the device when the door is closed. Depending upon the alarm mode selected, unauthorized opening of the door can either lock the door from further opening and instantaneously sound an alarm to protect an occupied dwelling, or sound an alarm after a predetermined time when the door has been fully opened to protect an unoccupied dwelling. A combination switch deactivates the alarm and chime modes. Other switches can alter the switch combination. A smoke detector may be integrated with the above.

### BACKGROUND OF THE INVENTION

This invention relates to an improved battery operated burglar alarm in combination with a door chime adapted to a door or the like.

Specifically, the device is an improvement in function and structure over my previously patented devices described in U.S. Pat. Nos. 4,123,752, 5,268,671 and Re 35,638. This device relates to an improvement in the sensing means with a simpler structure having fewer parts and easier assembly with increased reliability.

For example, the improvements in this invention to overcome the problems with the Novotny devices (Re U.S. Pat. No. 35,638, etc.) are as follows:

1. The entire and costly and unreliable mechanical sensing spring-activated plunger assembly (10, 12, 14) mounted to top cover (11), that requires direct contact with jamb plate (13) is eliminated including its cooperating make-break slide switch (15). Also, frictional wear caused by the rubbing action of plunger (12) against the bottom face of jamb plate (13) shortened the plunger (12) length after considerable use and affected the reliable triggering of break-make switch (15).

In this invention, to overcome the above cost and wear problems, components 10, 12, 14 and of Re 35,638 are replaced by a permanent magnet (12) integrated into jamb plate (13) and a reed switch (14) mounted to printed circuit board (23) to achieve the combination of electrical logic functions required.

2. The costly 3-position instant lock-alarm slide switch (22) mounted to printed circuit board (23) is eliminated including the slide switch actuator (21) attached to slide (19). Misalignment mating problems between slide switch button (22A) with slide switch actuator (21) arose during the assembly of the front cover subassembly to the back plate (2). The cutout in slide switch actuator (21) must precisely engage slide switch button (22A) during assembly of the front cover subassembly to the back plate (2) to which the printed board circuit (23) and hence the 3-position instant lock-alarm slide switch (22) is already attached.

In this invention, to overcome the above misalignment assembly problem, the costly 3-position instant lock-alarm slide switch (20) and slide switch actuator (21) of U.S. Pat. No. Re 35,638 are replaced by a single bifurcated spring (22) attached to slide (19). The contact legs of bifurcated spring (22) automatically align themselves to mate with printed circuit board pads (10) located on printed circuit board (23) as the front cover (11) is assembled to the back cover (2); the front cover (11) and back cover (2) each being part of front and back cover subassemblies respectively. This new structure prevents any final assembly misalignment problem between mating subassembly components during the final two subassemblies to form the final assembly of the Burglar Alarm and Door Chime.

This invention, like those of Re U.S. Pat. Nos. 35,638 and 5,268,671, includes the combination of instantaneous and simultaneous mechanical locking and alarm means for internal security and mode selection means for achieving the door chime mode or re-entry alarm delay mode. An optional smoke detector is also included.

Further, detailed background information may be found in Re U.S. Pat. Nos. 35,638 and 5,286,671 and, for brevity, is not repeated here, e.g.: reference to its use and advantages on doors in apartments, condos and single family homes.

### SUMMARY OF THE INVENTION

Accordingly, in addition to the objects and advantages described in my U.S. patents previously noted, the overall objects and advantages of the present invention are:

a) to provide a door-mounted security device having non-contact sensing means between the door-mounted device and its stationary doorjamb counterpart to provide a simpler structural combination and improve reliability and functions with either metal, plastic composite or wood fabricated doors.

b) to provide a door-mounted security device having three operating security modes and convenient switching means between operating modes, namely:

1) to instantaneously actuate a deadbolt lock and simultaneously sound an alarm when unauthorized opening of a door occurs.

2) to permit re-entry of an authorized person and allow sufficient delay time to de-arm the device and prevent the alarm from sounding.

3) to provide for a pleasant door chime tone mode to audibly monitor the opening and closing of a door during normal use.

4) to conveniently switch between re-entry and chime security modes.

c) to provide a device that can be manufactured to adapt within its structure a known smoke detection sensing unit having its own battery.

d) to manufacture a device that consists of two main subassemblies, namely: a mechanical and an electrical subassembly that are self-aligning during assembly to comprise the final assembly of the device.

e) to provide mechanical and electrical subassemblies that are complete by themselves and can be manufactured and tested independently of each other.

f) to provide a multiple color blinking light source visible from the front or side of the device that indicates the arming status of the instantaneous and delay arming modes.

Another object of the invention is to provide a security device that is easily installed on a door by the average homeowner, condo or apartment dweller without requiring special tools, material, knowledge, technique of rework of the existing door and frame structure.

It is still another object of this invention to provide homeowners and particularly condo and apartment dwellers, who must leave and return to their premises daily, a convenient, simple and reliable alarm device for their doors that does not require additional keys or other separate means to arm or de-arm the device upon leaving or entering their premises and means to change the de-arming code as needed.

Another object of this invention is to provide a device, the location of which is readily accessible to the authorized person but is mounted in a relatively inaccessible or tamper-proof location to the unauthorized person.

Still, a further object of this invention is to provide means for making the present device inoperative during periods of normal use.

The above objects as well as other and further objects, features and advantages of the present invention will be manifest in the following detailed description and preferred embodiment thereof when read in connection with the accompanying drawings which form a part of this specification. However, it must be clearly understood that these descriptions and drawings are not to be construed as defining the limits of the invention, for which purpose reference is made to the appended claims.

### DESCRIPTION OF THE PREFERRED EMBODIMENT

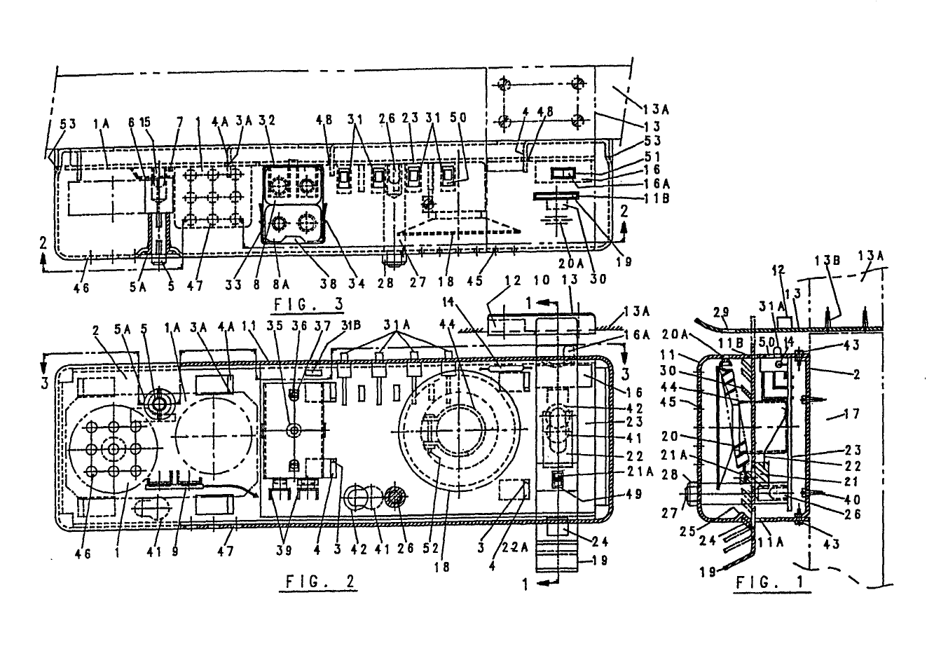

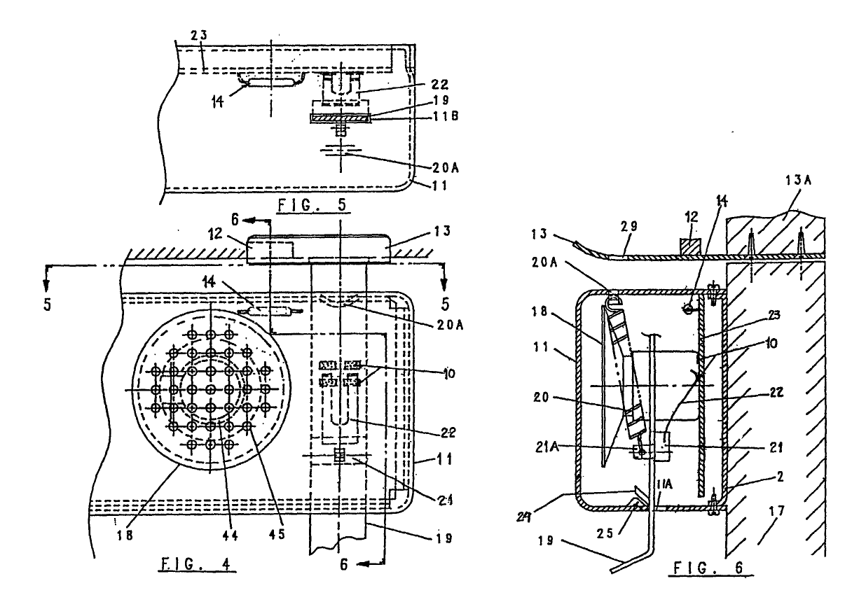

Refer in detail to the drawings, wherein like and related numerals and symbols designate like and related parts throughout the several views. FIG. 1 shows a sectional view of the device mounted to a door (17) by means of a back plate (2), preferably fabricated of metal using back plate screws (40) through back plate screw holes (41). Mounted to back plate (2) is a printed circuit board (23) to which switches, detailed electrical components, speaker and batteries with holder are fastened. Four back plate printed circuit board tabs (4) having “V” grooves (3) are shown in FIGS. 2 and 3 formed from back plate (2) to secure printed circuit board (23) against back plate (2) by means of an interference fit with printed circuit board slots (48). As a result, the printed circuit board assembly constitutes a completely independent electrical subassembly that cooperates with adjacent mechanical components to achieve the various operational modes.

A front cover (11), also preferably fabricated of metal, fits over back plate (2) and is fastened to back plate (2) using front cover screws (43). A slide (19) fits through the bottom and top surfaces of front cover (11) through front cover slide slots (11A and 11B) respectively to cooperate with jamb plate (13) containing jamb plate slot (29) and fastened to doorjamb (13A) using jamb plate screws (13B). Slide (19) has a lower slide tab (24) made to fit with a lower front cover detent (25) at its lower end and has an upper slide tab (30) at its other end. Spring-biased slide switch contact legs (22) attached to holder (21) is attached to slide (19). Spring-biased slide switch contact legs (22) contact, in turn, lower and upper printed circuit board contact pads (10) to respectively arm and lock-alarm the device. A slide switch holder tab (21A) of slide switch holder (21) fits through slide (19) by means of a slide tab slot (49). A spring (20) is attached to the end of slide switch holder tab (21A) and to the top end to upper front cover detent (20A).

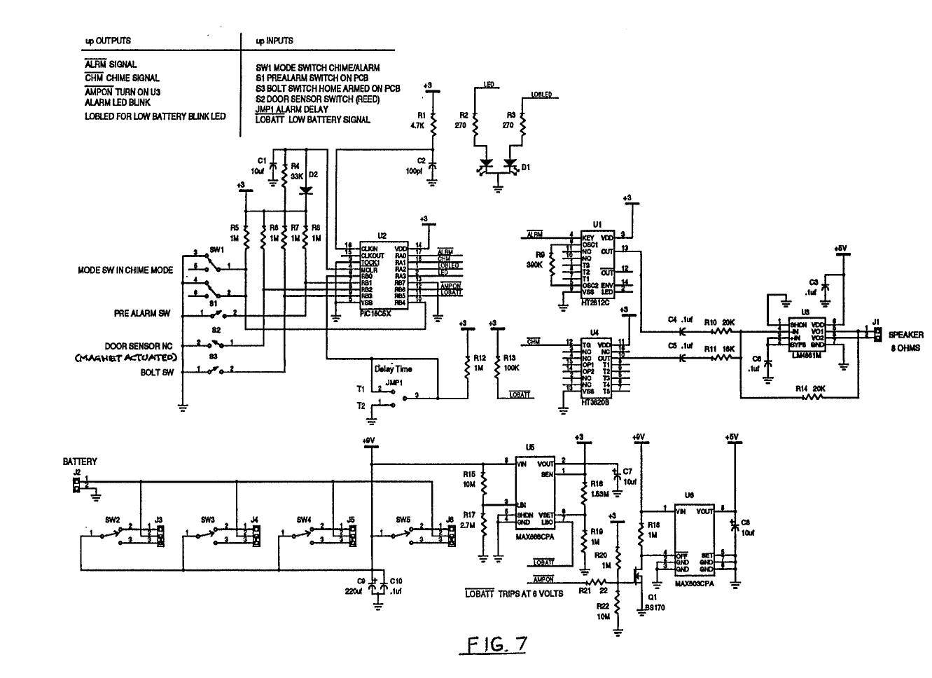

FIGS. 4, 5, and 6 show the magnetically sensitive switch (14) in relation to jamb plate (13) with mounted magnet (12) and their relationship to printed circuit board (23). Also, the relationship of spring-biased slide switch contact legs (22) is shown with respect to the lower and upper printed circuit board contact pads (10).

Four On/Off power two-position slide switches (31) are fastened to printed circuit board (23) at its top edge. The On/Off slide buttons (31 A) of On/Off power two-position slide switches (31) protrude above the top of front cover (11) through front cover top slots (50) for access as shown in FIGS. 1, 2, and 3.

FIGS. 2 and 3 show a chime and delay alarm mode selection two-position slide switch (16) fastened to printed circuit board (23) at its top edge. The chime and delay alarm mode selection slide button (16A) of chime and delay alarm mode selection two-position slide switch (16) protrudes above the top of front cover (11) through a front cover top slot (51) for access.

A bottom battery holder (32) is fastened to printed circuit board (23) with rivet (35) or suitable adhesive and stabilized with two battery holder key tabs (36) protruding through two circuit board key tab clearance holes (37). Two batteries (8 and 8A) are secured in place by a top battery holder (33) which fastens to battery holder (32) by snapping over and engaging two battery holder locking tabs (34). Battery (8) is electrically connected to printed circuit board (23) using two battery snap terminals (39) which, in turn, are mechanically fastened and electrically connected to printed circuit board (23). Battery (8) supplies power to the Burglar Alarm and Door Chime device. Battery (8A) supplies power to the optional smoke detector sensing unit (1). Top battery holder tabs (38) prevent battery (8A) from sliding out of position.

A light emitting diode (26) is fastened to printed circuit board (23) and transfers its light to the outside of front cover (11) by using a light conducting plastic cylinder (27) fastened to front cover (11) using a plastic cylinder retaining ring (28) and located in-line with light emitting diode (26).

A speaker (18) is fastened to printed circuit board (23) using a suitable adhesive or a mechanical speaker clamp (44) which, in turn, is adhesively bonded to circuit board (23). A multitude of speaker sound transmitting openings (45) are located in front cover (11) and in-line with speaker (18). Two printed board clearance holes (42) are provided for access to back plate screw holes (41). Front cover detents (53) of FIG. 3 located in the sides of front cover (11) provide for a fixed depth of assembly of back plate (2) with respect to front cover (11).

FIG. 7 shows a detailed electrical circuit schematic of the basic Burglar Alarm and Door Chime. Battery (8) supplies power to the Burglar Alarm and Door Chime device through the four On/Off power two-position slide switches (31) to the spring biased slide switch contact legs (22) and its circuitry, the chime and delay alarm mode selection two-position slide switch (16) and its circuitry. All of the foregoing actuate speaker (18) with its circuitry to sound an alarm and flash light emitting diode (26). Four jumper pin switches (31B) provide means to reverse the polarity of said four On/Off power two-position slide switches (31). Circuits to provide means to vary the entry delay time and warn of low battery voltage are included.

FIGS. 2 and 3 show an optional smoke detector sensing unit (1), fastened to back plate (2) and connected to battery (8A) using snap cable (9). Four back plate smoke detector tabs (4A) formed from back plate (2) and having “V” grooves (3A) provide a snap interference fit with the smoke detector's printed circuit board (1A) to which all smoke detector components are mounted. A multitude of smoke detector openings (47) are provided in addition to a multitude of smoke detector sound transmitting openings (46) are located in front cover (11).

A smoke detector light transmitting test plunger (5) is enclosed and captured by a smoke detector guide bushing (5A) which is snap fastened to front cover (11). The smoke detector light transmitting test plunger (5) is piloted over a smoke detector light transmitting diode (15) and is also in-line with a smoke detector sensing unit spring test contact (6) to enable contact with a smoke detector sensing unit fixed test contact (7) to check the working status of smoke detector sensing unit (1).

### OPERATION OF THE PREFERRED EMBODIMENT

The three modes of operation of the Burglar Alarm and Door chime are as follows:

1. Instant Lock-Alarm/Interior Security Mode:

Refer to FIG. 1 showing slide (19) in the “unarmed slide position” with door (17) closed. The four On/Off power two-position slide switches (31) are shown in FIG. 3 in a power “Off” mode with their slide tabs oriented toward the back plate (2). Move any one or several of the slide tabs (31A) toward the front cover (11) to effect the “On” mode of the four On/Off power two-position slide switches (31). Disengage slide tab (24) of slide (19) from the front cover detent (25) of front cover (11). Allow slide spring (20) to raise slide (19) until it engages the underside of jamb plate (13). During this movement, slide switch holder (21) of slide (19) will move spring-biased slide switch contact legs (22) to contact the lower printed circuit board contact pads (10) to effect the “armed slide position” from its original “unarmed slide position.” This slide position causes light emitting diode (26) to flash and transfer its light to the outside of front cover (11) by using light conducting plastic cylinder (27) fastened to front cover (11). The flashing light indicates to an authorized person located on the interior side of the second area that the device is in the armed mode. Unauthorized opening of door (17) causes slide (19) to pass through jamb plate slot (29) to achieve the “instant lock-alarm position” by effecting a dead bolt lock with jamb plate (13) and simultaneously moving spring-biased slide switch contact legs (22) to contact upper printed circuit board contact pads (10) to effect the “lock-alarm” mode and sound speaker (18). Moving slide (19) back to the “unarmed slide position” will not cause speaker (18) to stop sounding. However, placing the four On/Off power two-position slide switches (31) in the one “Off” mode known only to the authorized person will cause the speaker (18) to cease sounding.

2. Delay Alarm/Exterior Security Mode:

Refer to FIGS. 2, 3, and 7 with the door closed and showing the four On/Off power two-position slide switches (31) in the one “Off” mode and the chime and delay alarm mode selection two-position slide switch (16) in the right slide position to effect the Delay Alarm/ Exterior Security Mode. Placing the four On/Off power two-position slide switches (31) in one of the fifteen “On” combinations effects power to this mode and in cooperation with the magnet (12) mounted to jamb plate (13) and the magnetically sensitive switch (14) mounted to the printed circuit board (23) causes, at this time, light emitting diode to flash in a periodic series of three flashes in green light to further indicate the Delay Alarm/Exterior Security Mode is active in preparation to secure the interior area. Opening the door (17) from the interior area to be secured changes the state of magnetically sensitive switch (14) and, referring to FIGS. 6 and 7 causes light emitting diode (26) to commence flashing in a periodic series of two flashes in amber light which confirms the pre-arm condition of the Delay Alarm/Exterior Security Mode. The authorized person will then exit the interior area to be secured into the exterior area and close the door (17). This action causes the Delay Alarm/Exterior Security Mode of the device to arm; light emitting diode will cease flashing. Unauthorized opening of door (17) will cause speaker (18) to sound after a preset delay period and cause light emitting diode (26) to flash in a periodic series of single flashes of red light. Closing door (17) will not silence speaker (18) or cause light emitting diode (26) to cease flashing since the electric circuit is latched. However, placing the four On/Off power two-position slide switches (32) in the one “Off” combination known only to the authorized person will silence speaker (18) and cause light emitting diode (26) to cease functioning and de-arm the device.

3. Door Chime Annunciator Mode:

Referring again to FIGS. 2, 3, and 7 which show the four On/Off power two-position slide switches (31) in the one “Off” mode and the chime and delay alarm mode selection two-position slide switch (16) in the right slide position to effect the Delay Alarm/Exterior Security Mode. However, to achieve the Door Chime Annunciator Mode, move the chime and delay alarm selection two-position slide switch (16) to the left slide position and place the four On/Off power two-position slide switches (31) in any one of the fifteen “On” combinations. Opening and closing door (17), will alternately break and make the magnetically sensitive switch (14) due to magnet (12) and cause speaker (18) to emit pleasant chime tones.

4. Optional Smoke Detector Sensing Unit:

FIGS. 2 and 3 show an optional, independently powered smoke detector sensing unit (1) of known manufacture mounted to back plate (2). Smoke passing through smoke detector openings (47) in front cover (11) will trigger the smoke detector to sound through transmitting openings (46) also located in front cover (11). Pressing smoke detector light transmitting test plunger (5) checks the functionality of smoke detector sensing unit (1) by sounding its horn. Periodic flashing of light from light emitting diode (15) and transmitted to the tip of light transmitting test plunger (5) is a further indication of the unit's proper functionality, e.g.: low battery voltage.

While my above description contains many specificities, these should not be construed as limitations on the scope of the invention, but rather as an exemplification of one preferred embodiment thereof. Many other variations are possible. For example, the front cover (11) and back plate (2) may be fabricated of suitable plastics. Rocker or magnetic actuated switches may be substituted for the On/Off power two-position slide switches where applicable. Also, the number of power Off/On switches may vary from the four switches shown. A piezo-electric speaker may be used instead of the magnetic/coil type. Further, the slide (19) may be cylindrical in cross-section instead of rectangular and so forth. Also, a non-contact opto-electric sensing means using a light beam from a source mounted to the jamb plate and directed through a hole in the top of the front cover to a sensing receiver mounted to a printed circuit board or internal bracket within the hollow enclosure of the device to trigger electric logic circuits within the device is another non-contact sensing means.

Accordingly, the scope of the invention should be determined not by the embodiment illustrated, but by the appended claims and their legal equivalents.

1. A burglar alarm and door chime comprising:
a. a back plate fastened to the inside of a door and cooperating with electric circuit logic means further cooperating with an “instant lock-alarm” mode electric switching means, and “chime”/“delay alarm” modes electric switching means, and non-contacting sensing means cooperating with said “chime”/“delay alarm” modes electric switching means, audible alarm and chime means cooperating with electric power supply means, and “On” and “Off” power electric switch means, and
b. a front cover containing manual arming spring-biased “instant lock-alarm” slide means cooperating with said “instant lock-alarm” mode electric switching means of said burglar alarm and door chime when said front cover is fastened to said back plate, and
c. a jamb plate fastened to a doorjamb cooperating with said manual arming spring-biased “instant lock-alarm” slide means of said front cover during the opening of said door to effect the “instant lock-alarm” mode of said burglar alarm and door chime, and
d. said non-contacting sensing means consisting of a transmitting means attached to said jamb plate and a receiving means attached to said back plate, said receiving means responsive to said transmitting means to automatically activate and deactivate said “chime”/“delay alarm” modes electric switching means responsive to the opening and closing of said door to effect the selected mode of said burglar alarm and door chime (i.e. “chime” or “delay alarm” mode).

2. The burglar alarm and door chime of claim 1 wherein:
a. said spring-biased “instant lock-alarm” slide means cooperates with said “instant lock-alarm” switch means to effect an instant audible alarm having electric circuit latching means and also functions as a mechanical dead bolt lock in cooperation with said jamb plate, and
b. said “chime”/“delay alarm” modes electric switching means of said burglar alarm and door chime comprise manual selection mode switching means whereby “chime” or “delay alarm” operational modes may be manually selected for said burglar alarm and door chime, and
c. said audible alarm and chime means comprises a speaker, said “On” and “Off” power electric switch means comprising a plurality of accessible manually operated electric switching means in series with electric power supply means to manually activate or deactivate said burglar alarm and door chime and said electric power supply means comprises a battery.

3. The burglar alarm and door chime of claim 2 wherein:
a. said lock-alarm slide means comprises a slide having “armed,” “instant lock-alarm,” and “unarmed” slide positions slidably attached to said front cover, said slide being spring-biased to move through slots in said front cover to manually engage said jamb plate for the “armed” slide position, said jamb plate containing an aperture to automatically capture said slide during the opening of said door to effect the “instant lock-alarm” slide position, said slide having stop means engaging said front cover to effect the “unarmed” slide position, and
b. said transmitting means consisting of a permanent magnet attached to said jamb plate and cooperating with said receiving means attached to said back plate and consisting of a magnetically actuated switch responsive to said permanent magnet during the opening and closing of said door, said magnetically actuated switch cooperating with said “chime”/“delay alarm” modes electric switching means and said manual selection mode switching means to effect a “pre-arm” condition of said “delay alarm” operational mode of said “chime”/“delay alarm” modes electrical switching means during the opening of said door to activate said magnetically actuated switch and effect an “armed” condition of said “delay alarm” operational mode during the closing of said door, and causing a pre-set entry delay time means of said electric circuit logic means to cause said “delay alarm” operational mode of said “chime”/“delay alarm” electric switching means to be responsive to the opening of said door to activate said audible alarm means after a pre-determined delay time, or (if the “chime” mode of said manual selection mode switching means has been selected) to effect said “chime” operational mode during the opening of said door.

4. The burglar alarm and door chime of claim 3 wherein:
a. said electric circuit logic means includes variable time delay means for said “delay alarm” operational mode, and
b. light flashing means responsive to said “armed” slide position, said “instant lock-alarm” slide position and said “delay alarm” operational mode, and
c. said “On” and “Off” power electric switch means cooperating with additional electric switching means whereby the combination of said “On” and “Off” power electric switching means required to deactivate said burglar alarm and door chime can be altered.

5. The burglar alarm and door chime of claim 1 further including a smoke detection sensing unit fastened to said burglar alarm and door chime.

6. The burglar alarm and door chime of claim 5 wherein:
a. said smoke detection sensing unit comprises visual and manual functional testing means attached to said burglar alarm and door chime, and
b. includes an independent power supply means.

7. A burglar alarm and door chime comprising:
a. a back plate fastened to a front cover forming a hollow enclosure therewith, said back plate fastened to a door on the protected enclosure side of said door, said back plate having upper and lower and side surfaces to locate and fasten said front cover to said back plate, and
b. said front cover containing manual arming spring-biased “instant lock-alarm” slide means, a bifurcated leaf spring attached to said spring-biased “instant lock-alarm” slide means and electrically insulated therefrom, said bifurcated leaf spring cooperating with “instant lock-alarm” mode electric switching means fastened to a printed circuit board, said printed circuit board fastened to said back plate, and said “instant lock-alarm” mode electric switching means cooperating with electric circuit logic means of said printed circuit board, and
c. non-contact sensing means cooperating with “chime”/“delay alarm” modes electric switching means of said electric circuit logic means of said printed circuit board, and said non-contacting sensing means consisting of a transmitting means attached to a jamb plate, and a receiving means attached to said printed circuit board of said back plate, said receiving means responsive to said transmitting means to automatically activate and deactivate said “chime”/“delay alarm” modes electric switching means responsive to the opening and closing of said door to effect the selected mode of said burglar alarm and door chime (i.e. “chime” or “delay alarm” mode), and
d. said transmitting means consisting of a permanent magnet and said receiving means consisting of a magnetically actuated switch, and
e. said jamb plate having an opening there through and fastened to a door jamb and cooperating with said manual arming spring-biased “instant lock-alarm” slide means of said front cover during the opening of said door to effect the “instant lock-alarm” mode of said burglar alarm and door chime, and f said printed circuit board containing audible alarm and chime means and cooperating with “On” and “Off” power electric switching means cooperating with electric circuit logic means to activate or deactivate said burglar alarm and door chime in combination with electric power supply means.

8. The burglar alarm and door chime of claim 7 wherein:
a. said spring-biased “instant lock-alarm” slide means cooperates with said “instant lock-alarm” switch means to effect an instant audible alarm having electric circuit latching means and also functions as a mechanical dead bolt lock, in cooperation with said jamb plate, and
b. said “chime”/“delay alarm” modes electric switching means of said burglar alarm and door chime comprise manual selection mode switching means whereby “chime” or “delay alarm” operational modes may be manually selected for said burglar alarm and door chime, and
c. said audible alarm and chime means comprises a speaker, said “On” and “Off” power electric switch means comprises a plurality of accessible manually operated electric switching means in series with said electric power supply means to manually activate or deactivate said burglar alarm and door chime and said electric power supply means comprises a battery.

9. The burglar alarm and door chime of claim 8 wherein:
a. said lock-alarm slide means comprises a slide having “armed,” “instant lock-alarm,” and “unarmed” slide positions slidably attached to said front cover, said slide being spring-biased to move through slots in said front cover to manually engage said jamb plate for the “armed” slide position, said jamb plate containing an aperture to automatically capture said slide during the opening of said door to effect the “instant lock-alarm” slide position, said slide having stop means engaging said front cover to effect the “unarmed” slide position, and
b. said permanent magnet attached to said jamb plate being a rare earth permanent magnet and said magnetically actuated switch being a magnetically responsive reed switch, said rare earth permanent magnet and said magnetically responsive reed switch cooperating with said manual selection mode switching means to effect a pre-arm condition of said “delay alarm” operational mode of said “chime”/“delay alarm” modes electrical switching means during the opening of said door and cause said magnetically responsive reed switch to effect the “armed” condition of said “delay alarm” operational mode during the closing of said door and causing a pre-set entry delay time means of said electric circuit logic means to cause said “delay alarm” operational mode of said “chime”/“delay alarm” electric switching means to be responsive to the opening of said door to activate said audible alarm means after a predetermined delay time, or (if the “chime” mode of said manual selection mode switching means has been selected) to effect said “chime” operational mode during the opening of said door.

10. The burglar alarm and door chime of claim 9 wherein:
a. Said electric circuit logic includes variable time delay means for said “delay alarm” operational mode, and light flashing means responsive to said “armed” slide position, said “instant lock-alarm” slide position and said “delay alarm” operational mode, and said “On” and “Off” power electric switch means cooperating with additional electric switching means whereby the combinations of said “On” and “Off” power electric switching means required to deactivate said burglar alarm and door chime can be altered.

11. The burglar alarm and door chime of claim 7 further including a smoke detection sensing unit fastened to said burglar alarm and door chime.

12. The burglar alarm and door chime of claim 11 wherein said smoke detection sensing unit comprises visual and manual functional testing means attached to said burglar alarm and door chime and includes an independent power supply means.

13. A burglar alarm and door chime comprising:
a. an electrical subassembly mounted to a circuit board and containing electric circuit logic means, and electric power supply means, said electric circuit logic means comprising “instant lock-alarm” and “chime”/“delay alarm” modes electric switching means, said electrical subassembly mounted to said circuit board comprising a self-contained operational electrical subassembly unit detachably secured to a back plate, said back plate fastened to a door, and
b. a mechanical subassembly comprising a front cover and said front cover comprising mechanical manual arming spring-biased “instant lock-alarm” actuation means, spring-biased switching means attached to said manual arming spring-biased “instant lock-alarm” actuation means and cooperating with said circuit board detachably secured to said back plate to effect said “instant lock-alarm” mode of said burglar alarm and door chime during the opening of said door, and
c. non-contacting sensing means cooperating with “chime”/“delay alarm” modes electric switching means of said circuit board logic means, and said non-contacting sensing means comprising switch actuation means attached to said circuit board responsive to transmission media means attached to a jamb plate further attached to a door jamb to effect the “chime”/“delay alarm” modes electric switching means during the opening and closing of said door, and
d. manually operated mode selection switching means attached to said circuit board of said self-contained operational electrical subassembly unit to manually effect the mode of choice for said “chime”/“delay alarm” modes electric switching means for said burglar alarm and door chime, and
e. said manual arming spring-biased “instant lock-alarm” actuation means cooperating with said jamb plate attached to said doorjamb to simultaneously provide for a mechanical deadbolt locking mode, and
f. an audible alarm means responsive to said manual arming spring-biased “instant lock-alarm” actuation means and said “chime”/“delay alarm” modes electric switching means, said audible alarm means cooperating with said electric power supply means to sound an alarm upon the opening of said door, and
g. “On” and “Off” power electric switch means cooperating with said electric power supply means to activate or deactivate said burglar alarm and door chime, and said “On” and “Off” power electric switch means cooperating with additional switch means whereby the combination of said “On” and “Off” power electric switch means required to deactivate said burglar alarm and door chime can be altered, and said “delay alarm” means having variable time delay means cooperating with said electric circuit logic means.

14. The burglar alarm and door chime of claim 13 wherein said electric circuit logic includes light flashing means responsive to “armed” and “dead-bolt lock” operational states of said manual arming spring-biased “instant lock-alarm” actuation means and said “delay alarm” operational state of said “chime”/“delay alarm” modes.

15. The burglar alarm and door chime of claim 13 further including a smoke detection sensing unit independently fastened to said back plate and including independent power supply means, said smoke detection sensing unit comprising visual and manual functional testing means attached to said front cover of said mechanical subassembly, to visually and manually operationally test said smoke detection sensing unit from said front cover.

16. A burglar alarm and door chime comprising:
a. a back plate fastened to the inside of a door having a front cover detachably secured to said back plate, said back plate and said front cover forming a hollow enclosure therein, said hollow enclosure containing electric circuit logic means cooperating with an “instant lock-alarm” mode electric switching means and “chime”/“delay alarm” modes electric switching means, said “chime”/“delay alarm” modes electric switching means accessibly secured to said hollow enclosure, audible alarm and chime means and electric power supply means, and
b. “On” and “Off” power electric switch means accessibly secured to said hollow enclosure and cooperating with said electric circuit logic means and said electric power means, and
c. a manual arming spring-biased slide means attached to said hollow enclosure and cooperating with said “instant lock-alarm” mode electric switching means of said electric circuit logic means, and
d. non-contacting sensing means consisting of transmitting means attached to a jamb plate and receiving means attached to said back plate of said hollow enclosure cooperating with said “chime”/“delay alarm” modes electric switching means of said electric circuit logic means to automatically effect said “chime”/“delay alarm” modes of said burglar alarm and door chime responsive to the manual selection of said “chime”/“delay alarm” modes electric switching means (i.e. “chime” or “delay alarm” mode) responsive to the opening and closing of said door.

17. The burglar alarm and door chime of claim 16 wherein:
a. said manual arming spring-biased slide means cooperating with said “instant lock-alarm” mode electric switch means to effect an instant audible alarm having electric circuit latching means and also functions as a mechanical dead-bolt lock in cooperation with said jamb plate, and
b. said “chime”/“delay alarm” modes electric switching means comprise manual switching means accessibly secured to said front cover of said hollow enclosure cooperating with said non-contact sensing means whereby “chime” or “delay alarm” operational modes may be manually selected, and
c. said audible alarm and chime means comprises a speaker, said “On” and “Off” power electric switch means comprises a plurality of accessible manually operated switching means in series with said electric power supply means to manually activate or deactivate said burglar alarm and door chime and said electric power supply means comprises a battery.

18. The burglar alarm and door chime of claim 17 wherein:
a. said lock-alarm slide means comprises a slide having “armed,” “instant lock-alarm,” and “unarmed” slide positions slidably attached to said front cover, said slide being spring-biased to move through slots in said front cover to manually engage said jamb plate for the “armed” slide position, said jamb plate containing an aperture to automatically capture said slide during the opening of said door to effect the “instant lock-alarm” slide position, said slide having stop means engaging said front cover to effect the “unarmed” slide position, and
b. said transmitting means and said receiving means of said non-contacting sensing means consisting of a permanent magnet (transmitting means) attached to said jamb plate and a magnetically actuated switch (receiving means) attached to a printed circuit board attached to said back plate of said hollow enclosure, both cooperating with said “chime”/“delay alarm” modes electric switching means of said electric circuit logic means and cooperating with said manual selection mode switching means to effect a “pre-arm” condition of said “delay alarm” operational mode of said “chime”/“delay alarm” modes electrical switching means during the opening of said door and cause said magnetically actuated switch cooperating with said permanent magnet attached to said jamb plate to effect an “armed” condition of said “delay alarm” operational mode during the closing of said door, and causing a pre-set entry delay time means of said electric circuit logic means to cause said “delay alarm” operational mode of said “chime”/“delay alarm” electric switching means to be responsive to the opening of said door to activate said audible alarm means after a pre-determined delay time, or (if the “chime” mode of said manual selection mode switching means has been selected) to effect said “chime” operational mode during the opening of said door.

19. The burglar alarm and door chime of claim 18 wherein said electric circuit logic means includes variable time delay means for said “delay alarm” operational mode and light flashing means responsive to said “armed” slide position, said “instant lock-alarm” slide position and said “delay alarm” operational mode, said “On” and “Off” power electric switch means cooperating with additional electric switching means whereby the combination of said “On” and “Off” power electric switching means required to deactivate said burglar alarm and door chime can be altered.

20. The burglar alarm and door chime of claim 16 further including a smoke detection sensing unit fastened within said hollow enclosure of said burglar alarm and door chime wherein said smoke detection sensing unit includes an independent power supply means and comprises visual and manual functional testing means cooperating with said smoke detection sensing unit.
